(19) United States
(12) Patent Application Publication
(10) Pub. No.: US 2004/0186739 A1
(43) Pub. Date: Sep. 23, 2004

(54) Customer configurable system and method for alarm system and monitoring service

(76) Inventors: David Bolles, San Diego, CA (US); Robert J. Brainard, Scottsdale, AZ (US)

Correspondence Address: Damon L. Boyd, Snell & Wilmer L.L.P., One Arizona Center, 400 East Van Buren, Phoenix, AZ, 85004-2202, US

(21) Appl. No.: 10/698,974

(22) Filed: Oct. 31, 2003

Related U.S. Application Data
(60) Provisional application No. 60/423,031, filed on Nov. 1, 2002.

(51) Int. Cl. G06F 17/60

(52) U.S. Cl. 705/1

(57) ABSTRACT

In accordance with various embodiments of the present invention, an alarm system comprising a controller unit, capable of interfacing with standard alarm sensors and existing alarm panels; a configuration mechanism (such as a web site) through which a user can configure notification parameters and/or contact methods for the different types of events, and an automated dispatching mechanism which serves to make contact with the user, or others designated by the user, as defined by the configuration mechanism, along with data corresponding to the event (e.g., camera image when sensor trips).

### CROSS-REFERENCE TO RELATED APPLICATIONS

This application is a continuation of United States Provisional Patent Application Serial No. 60/423,031 entitled “Customer Configurable System And Method For Alarm System And Monitoring Service,” filed Nov. 1, 2002, and is incorporated herein by reference.

### FIELD OF THE INVENTION

The present invention relates to alarm security systems and monitoring services, and more particularly, to a method and system for allowing a customer to configure and control how the alarm system responds to events and how the system dispatches cascading communications and notifications of those events.

### BACKGROUND OF THE INVENTION

Existing alarm systems are generally inflexible and allow little or no control of how the alarm system responds to different events or how the monitoring service dispatches communications based on those events.

For example, a typical alarm system such as that shown in FIG. 1, consists of an alarm panel 100 connected to various door, window or other sensors 103. These sensors 103 can be wireless or wired and can communicate with the alarm panel through various protocols and mechanisms. Some of sensors 103 may allow some limited configuration via the alarm panel, while others have no configuration parameters.

The alarm system illustrated in FIG. 1 further consists of a connection to a telephone line, through which the alarm panel 100 makes a call to a monitoring station 102 when one or more of sensors 103 detect an alarm event (e.g., a break in, fire or the like). When the event occurs, the alarm panel 100 calls a central monitoring station 102 which provides a “monitoring service” for the alarm system. Often, the monitoring station 102 is not in the same locale as the monitored area and, in fact, it is not uncommon for the monitoring facility to be in a separate state.

When personnel at the central monitoring station 102 receive an alarm event notification, a call is made to a phone number for the account to which the alarm system is registered. The personnel then asks for a password to disable the alarm in the case where the alarm event was an accidental trip of the alarm system. Such false alarms are often triggered by the weather, an open window, user error, the family pet or the like comprise the vast majority of “alarm events” reported and, recently, municipalities have begun to charge for the dispatch of the emergency service after a certain number of “false” events have been received.

If the personnel does not receive a valid password or if no one answers the phone when they call, they then call the local police department or other emergency service to respond to the event.

Thus, existing alarm system architectures are fixed, inflexible, and affords the user little or no control over how events are processed or the decisions that result from those events. Improved alarm systems are therefore desirable. In particular, a system which allows a user to completely customize how the alarm system reacts in the case of an alarm event is desirable. It is further desirable to have the alarm system automate the process of dispatch, using modern communications devices, in sequence or parallel, to maximize notification effect. It is also desirable to have the alarm system provide amplifying/further data about the event during notifications (for example, digital), so the user can examine the probable cause of the event before notifying authorities (e.g., send an image of the home along with the sensor that triggered it), so the user can actually see what caused the event, and where the dispatch should be sent (e.g., to the user's image ready cell phone).

### SUMMARY OF THE INVENTION

While the way that the present invention addresses the disadvantages of the prior art is discussed in greater detail below, in general, the present invention provides an improved alarm system. For example, in accordance with the present invention, the alarm system provides the capability for the user to control how the system responds when an “alarm event” (or other type of event such as a flood, fire, medical emergency or the like) has been detected.

For example, in accordance with various embodiments of the present invention, alarm system comprises a controller unit, capable of interfacing with standard alarm sensors and existing alarm panels; a configuration mechanism (such as a web site) through which a user can configure notification parameters and/or contact methods for the different types of events, and a dispatching mechanism which serves to make contact with the user, or others designated by the user, as defined by the configuration mechanism.

In various exemplary embodiments, the dispatching mechanism contacts users by various methods including, but not limited to: home phone, work phone, cell phone, cell phone SMS, e-mail, fax, pagers, or various instant messenger services, thereby enhancing user notification of response to alarm events. Such configurations also provide users with more control over how the system works to match their preferences and lifestyles.

Alternatively or in addition to notification in response to an alarm event, system may perform any number of other “active” responses beyond mere notification, such as, for example, activating sprinklers, locking or closing doors, turning lights on or off, enabling a camera or video recorder device, or any number of such “active” responses.

### BRIEF DESCRIPTION OF THE DRAWINGS

A more complete understanding of the present invention may be derived by referring to the detailed description when considered in connection with the Figures, where like reference numbers refer to similar elements throughout the Figures, and:

FIG. 1 is a block diagram of a conventional alarm system;

FIG. 2 is a block diagram of an alarm system in accordance with the present invention;

FIGS. 3-9 are website screen shots of an exemplary embodiment of the present invention; and

FIG. 10 is a block diagram of an alternative embodiment of an alarm system in accordance with the present invention.

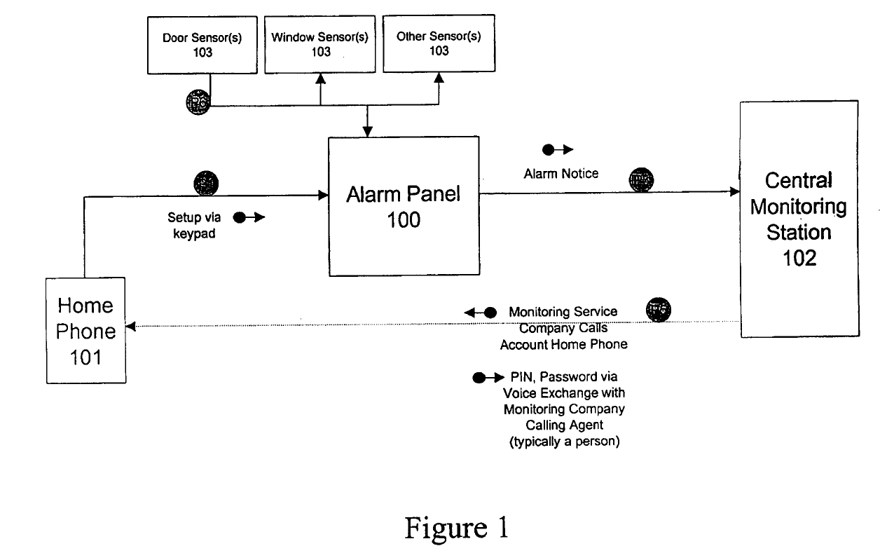

### DETAILED DESCRIPTION

The following description is of exemplary embodiments of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention as set forth herein. For example, in the context of the present invention, the method and apparatus hereof find particular use in connection with home alarm systems. However, generally speaking, the present invention is equally applicable to various other applications, such as, for example, commercial alarm systems. Likewise, though various portions of the specification refer to particular communication means, various other means, now known or as yet unknown, having similar properties should be considered within the scope of the present invention.

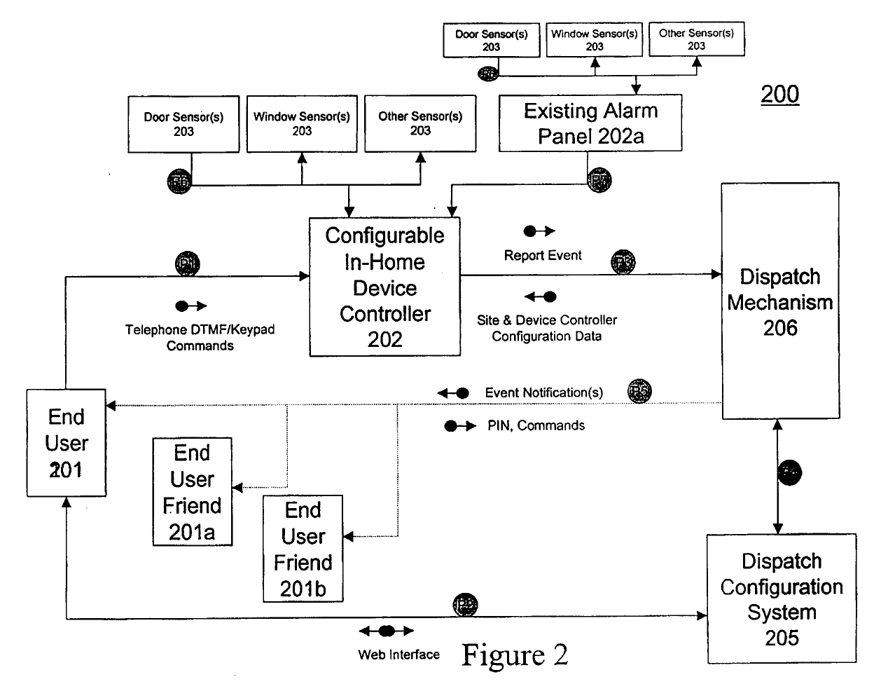

That being said, in accordance with various aspects of the present invention and with reference to the exemplary embodiment illustrated in FIG. 2, the present invention provides an improved alarm system. For example, the present invention provides an alarm system 200 which allows a user 201 to control how the system responds when an “alarm event” has been detected.

For example, in accordance with various embodiments of the present invention, alarm system 200 comprises a controller unit 202 which suitably interfaces with standard alarm sensors 203 (such as those mentioned above and with as yet unknown sensors), and existing or as yet unknown alarm panels; a dispatch configuration system 205 (which may further comprise a web site or other remote interface device) through which user 201 can configure alarm notification parameters and/or contact methods for the different types of alarm events; and a dispatch mechanism 206 which serves to make contact with user 201, or others (such as friends of user) 201a,b designated by user 201, as defined by configuration system 205.

It should be appreciated that in its various embodiments, alarm system 200 may have various “fail-safe” aspects to assist in ensuring that alarm system 200 will work as expected in a variety of expected and unexpected conditions (e.g., power failure, telephone failure, other interference). For example, various redundancies may be built into system 200, such as back-up communication means (e.g., terrestrial telephone lines/cellular/Intemet), back-up notification configurations (e.g., telephone emergency response team/telephone user 201/telephone family member) and other such fail-safe aspects. Similarly, isolation of alarm system 200 components may likewise provide “fail-safe” like aspects. For example, in various embodiments of the present invention, various components of system 200 may be remotely located from one another. Stated otherwise, for example, controller 202 may be in a living room of user's 201 home, dispatch mechanism 206 may be located a central provider of system 200 and dispatch configuration system 205 may be another location. Thus, in the event of some failure at one of the locations (e.g., power, fire or otherwise), the entire system is not destroyed, and in fact various surviving components may suitably perform similar functions as destroyed or incapacitated components, thereby preserving the integrity of the system. Relatedly, the various alarm notification parameters may be configured as independent from one another, further providing potential advantages in the event of various “failures”.

In accordance with further advantages of the present invention, the timing of actions taken upon the occurrence of an alarm event may be suitably determined in advance by the user. For example, in the event of some alarms, the user may desire the system to place a phone call to a number of persons, and in accordance with the present invention, such calls may be done consecutively (one after another) or in parallel (simultaneously). Similarly, in the event a first action is taken, but unable to be completed (e.g., no answer to a phone call to a first person), a second action, such as a phone call to a second person, is automatically made.

In accordance with still further advantages of the present invention, various information/data can be transmitted to a user-defined place upon occurrence of an alarm event may be suitably determined in advance by the user. For example, it may be desirable to provide a data packet relating to an area monitored by system 200 upon an alarm event. An example of such data comprises video footage or an image of the area, allowing features such as validation/authentication of the event and selection of appropriate primary and back-up actions to be taken.

Still further in accordance with the present invention, system 200 is suitably configurable to prioritize alarm notification parameters based on user input variables. For example, one exemplary variable comprises time of day settings. That is, in some instances, it may be desirable to have different actions taken depending on the time of day for an alarm event. For example, when the user is away from a monitored home during the user's normal work hours, the action taken in the event of a fire may be to immediately telephone a fire department. In contrast, when the user is present, the action taken may be to immediately sound an alarm and (consecutively or simultaneously) telephone the fire department.

In any event, it should be apparent that many advantages are realized with the present invention and that any number of parameters, events, actions and the like now known or as yet unknown may be taken and freely configured in accordance with a user's desires. Actual exemplary descriptions of embodiments and operations of the present invention are described herein, with reference to the attached Figures.

In various exemplary embodiments, dispatching mechanism 206 contacts users 201, 201a,b by various methods including, but not limited to: home phone, work phone, cell phone, cell phone SMS, e-mail, fax, pagers, or various instant messenger services, thereby enhancing user notification of response to alarm events. Such configurations also provide users with more control over how the system works to match their preferences and lifestyles.

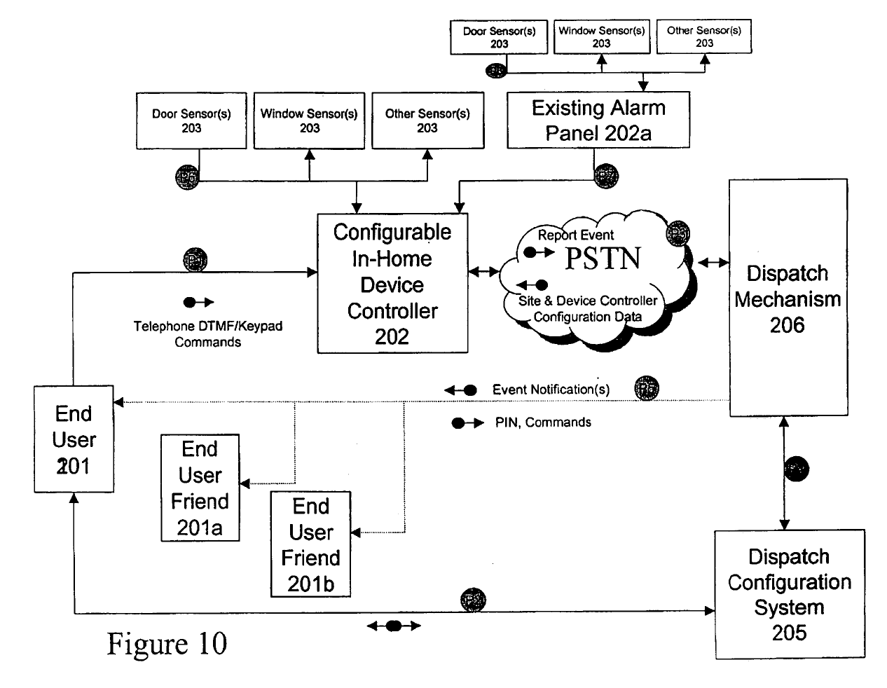

With continuing reference to FIG. 2, in accordance with an exemplary embodiment of the present invention, alarm system 200, through controller 202 interfaces with dispatch mechanism 205 (or other components of system 200) via various communications means (e.g., a public switched telephone network with simple modems, as in FIG. 10,to high speed data transmission lines such as cable, DSL or the like) to download firmware, software updates, configuration information and the like, or otherwise delegate and prioritize tasks, based upon, inter alia, user 201 input and/or preferences. Likewise, controller 202 interfaces with various sensors 203 (e.g., attached to doors, windows, or the like, and/or smoke, fire, flood or other condition sensing devices) in the monitored area.

In accordance with various aspects of the presently described embodiment, controller 202 suitably comprises a conventional user panel 202a, thereby allowing the present invention to be used in both new alarm system installations (where this invention provides all of the alarm system functionality), or as an add-on or “retro-fit” components to an existing third-party alarm system installation. In such instances, various interfaces and protocols enabling interaction with existing third-party alarm system installations are supported. Alternatively, newly designed panels may likewise be used in various alternative embodiments of the present invention.

In accordance with various embodiments of the present invention, dispatch mechanism 206 is provided. Dispatch mechanism 206 suitably allows user 201 to setup custom alarm dispatch requirements and instructions, and optionally, further allows user 201 to add others 201a,b to be notified in the event of an alarm. For example, others 201a,b may be added to a personal address book or other storage mechanism. Thus, in its various embodiments, the present invention removes the need to actually call a designated telephone number as required by existing alarm systems, but rather, allows contact to occur through previously unavailable channels. Additionally, such contact mechanisms may allow multiple contacts per account (instead of calling one designated telephone number).

In various embodiments, dispatch mechanism 206 is controlled via dispatch configuration system 205. For example, dispatch configuration system 205 comprises any interface which allows user 201 to set actions which occur in the event of an alarm, such as a website, PDA, cell for or other interfacing device, now known or as yet unknown.

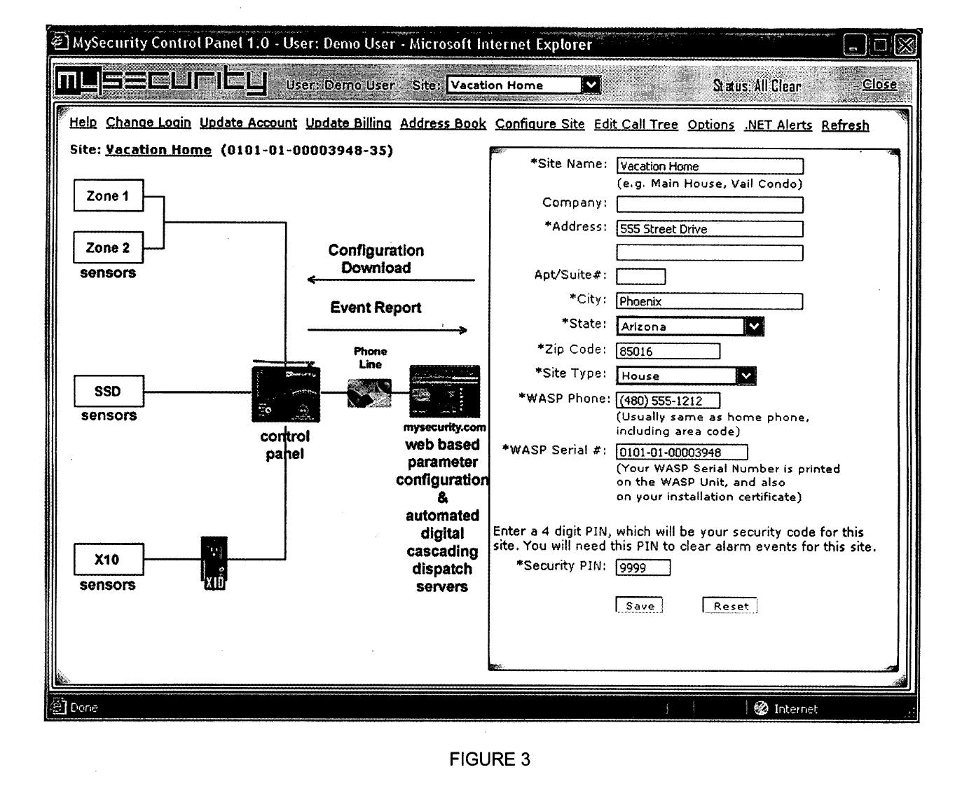

With reference now to FIGS. 3-9, a website/intemet based embodiment of the present invention which enables user 201 to control the function, operation, and dispatch parameters of alarm system 200 is illustrated. In such contexts controller 202 communicates with dispatch mechanism 206 to obtain user's 201 configuration parameters. In accordance with various aspects of such embodiments, controller 202 is capable of being reprogrammed at regular intervals (e.g., every night or at other appropriate intervals) to conform to the configuration settings that user 201 has set for system via the dispatch configuration system 206. As mentioned above, in accordance with various embodiments of the present invention, various interfaces and protocols are supported for the interface between controller 202 and dispatch controller server 206, including, but not limited to phone line connection, internet connection, DSL connection, wireless connection, using protocols including but not limited to TCP/IP, proprietary protocols and the like.

An example exemplary implementation of dispatch mechanism 206 in operation is illustrated in FIGS. 3-9. These web pages show an exemplary implementation whereby user 201 can setup and configure their alarm system operation by navigating a number of web pages on an Internet site. This Internet site then communicates with the dispatch mechanism 206 to save a configuration state, so that when an alarm event occurs, dispatch mechanism 206 can determine how to respond and dispatch event notification messages.

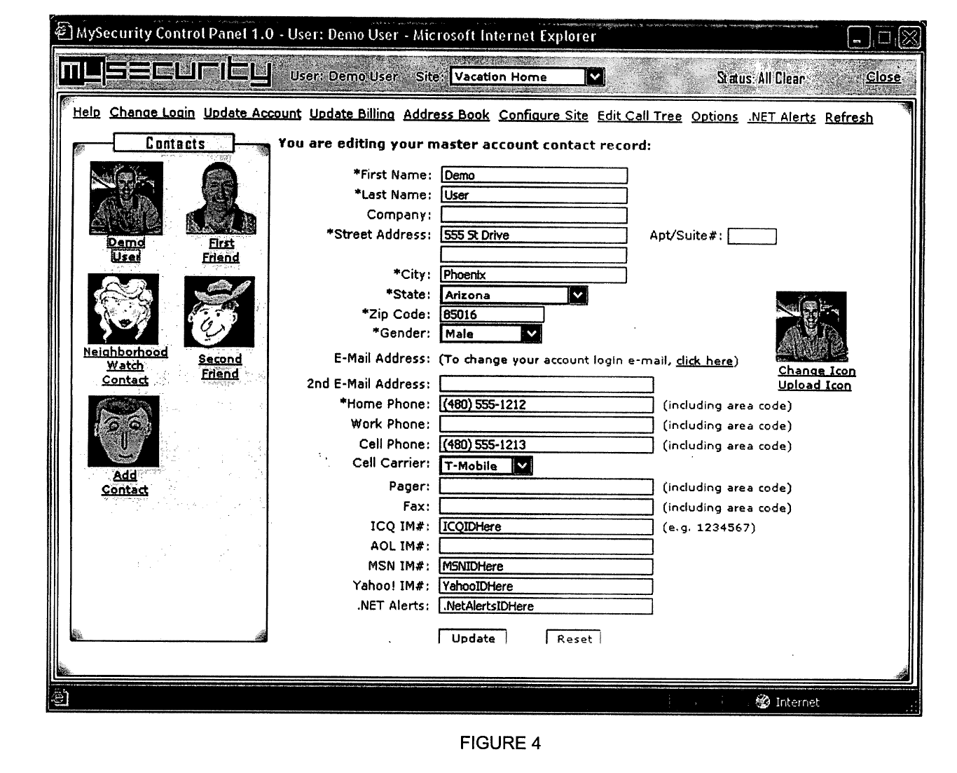

With reference to FIGS. 3 and 4 screen shots illustrate how user 201 can set high-level account information for alarm system 200.

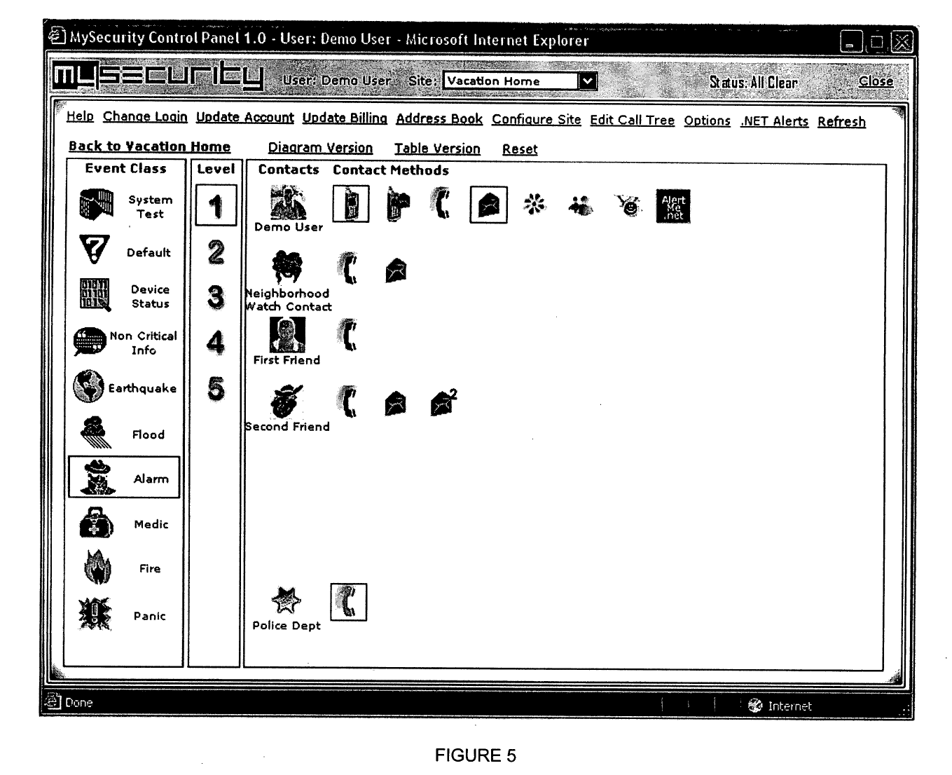

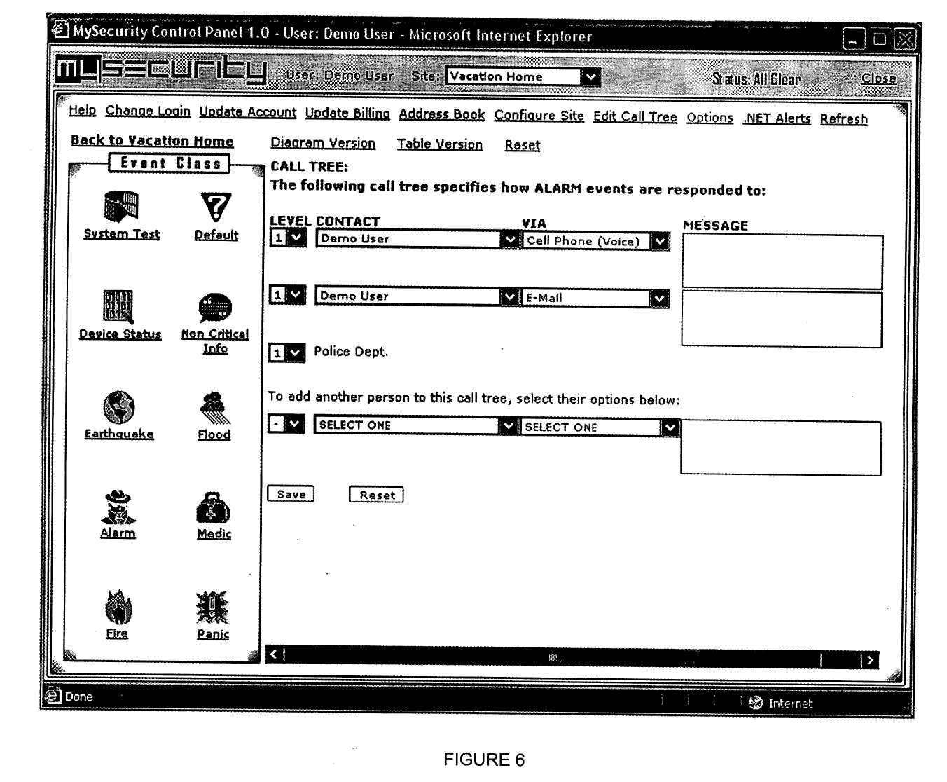

FIGS. 5 and 6 show screen shots illustrating how user 201 specifies who they want to be contacted and in which order (a level) when an alarm event of a specified type occurs.

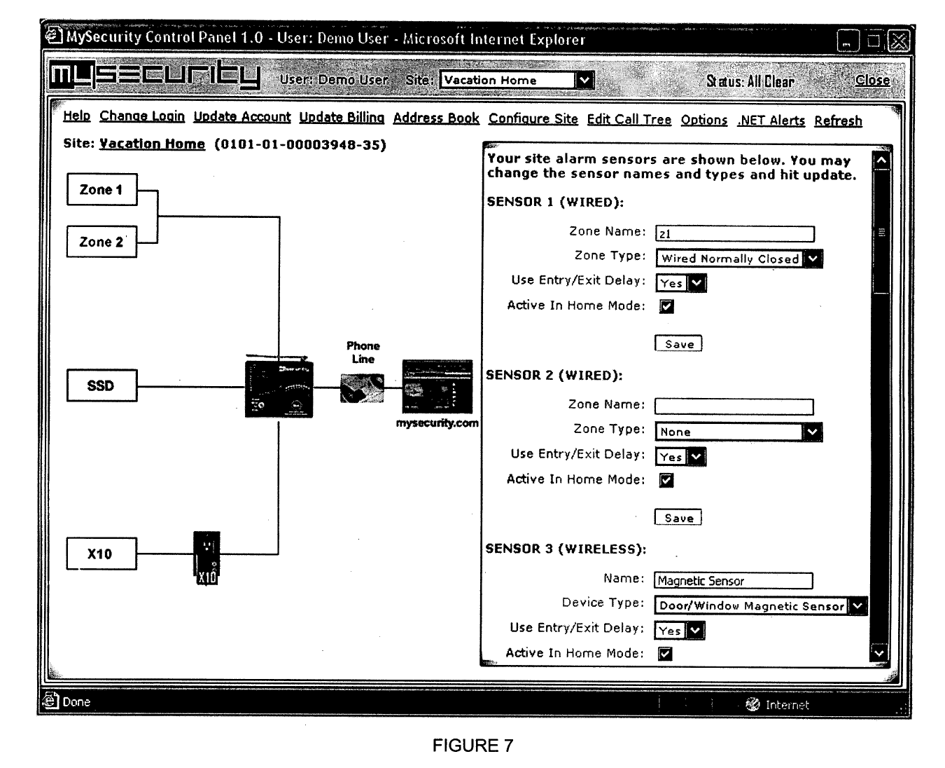

FIG. 7 shows a screen shot whereby user 201 specifies the type of wireless sensors connected to configurable in home device controller 202.

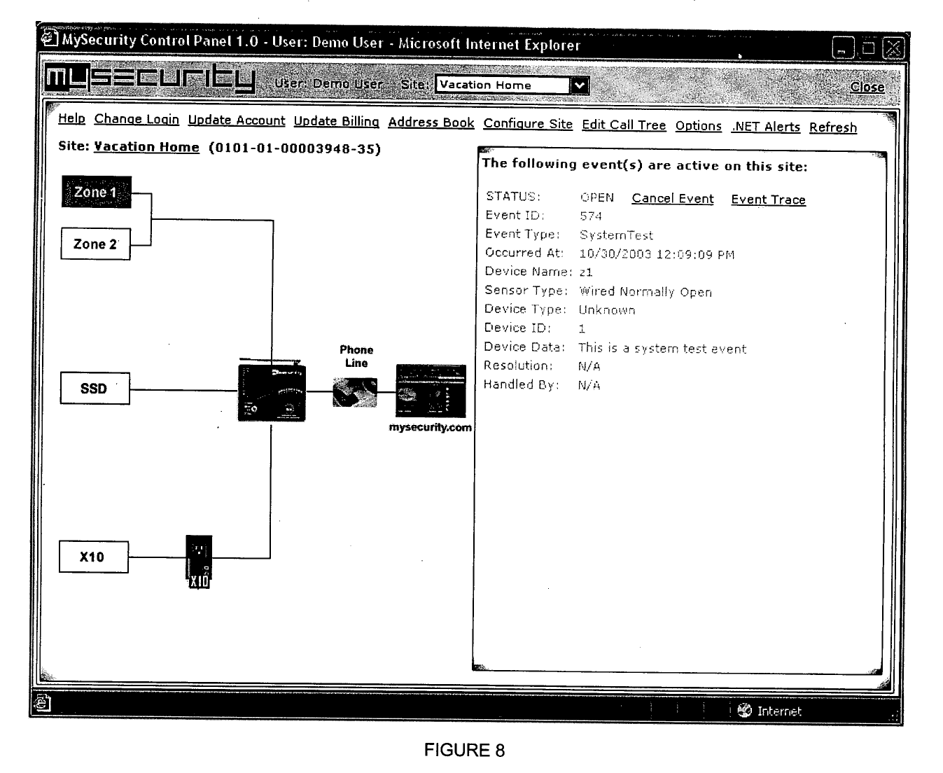

FIG. 8 is a screen shot whereby user 201 specifies the alarm zones (connected via existing alarm panel 202a) connected to configurable in home device controller 202.

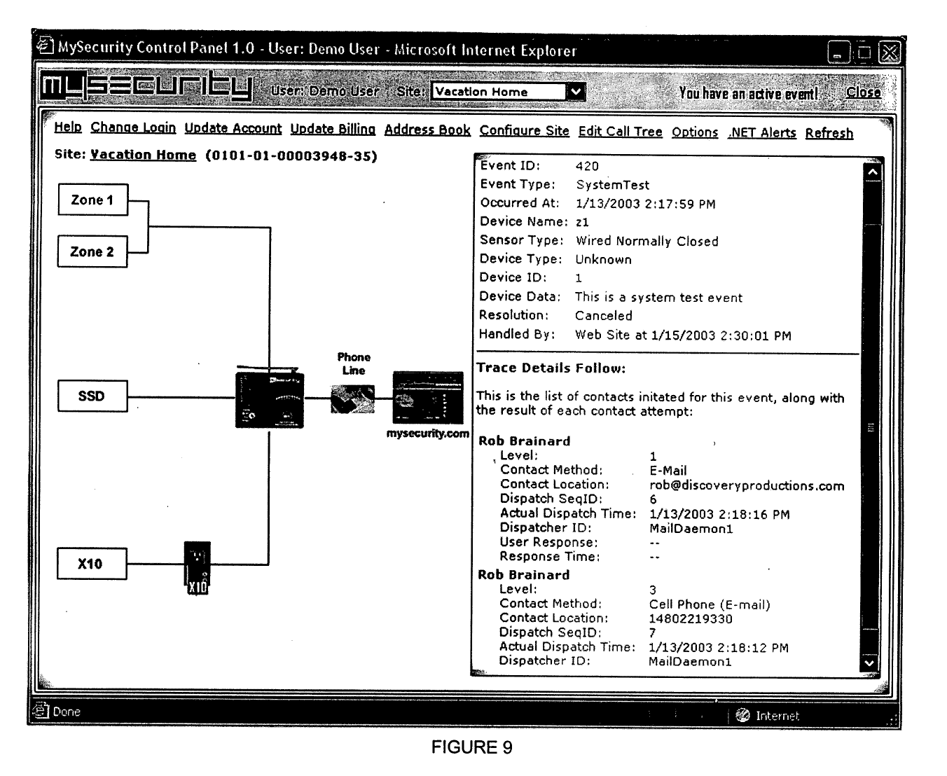

FIG. 9 is a screen shot whereby user 201 specifies certain X10 devices connected to configurable in home device controller 202.

In accordance with various aspects of the present invention, it should also be appreciated that configurable in home device controller 202 may be configured to automatically detect the various sensor types and locations connected to it, and, optionally, report that information back to dispatch configuration system 205, so that user 201 does not have to enter initial information. In such embodiments, this auto-detection capability varies by hardware and sensor type, and generally does not affect overall dispatch configuration system 205 operation.

During the operation of the present invention, when an alarm event is sensed by one of sensors 203, controller 202 reports the event to dispatch mechanism 206. Such reporting is performed by any suitable communication means. For example, the reporting may be performed using a phone similar to typical alarm systems. However, alternatively, other communication means likewise fall within the scope of the present invention and include, among others, TCP/IP or other protocol communications or other communications channels such as the via the Internet or a DSL/PPP connection.

When an event is received by dispatch mechanism 206, event handling dispatch instructions are retrieved from dispatch configuration system 205, and contact sequences are initiated to users 201, 201a,b, according to the instructions previously provided by user 101 through controller 202. In accordance with additional aspects of the present invention, each different type of alarm sensor/event type can have separate dispatch contact instructions and may contact completely different users 201, 201a,b depending on user 101 desires.

Thus, during an exemplary alarm event, dispatch mechanism 206 contacts users 201, 201a,b through various means and protocols, including, but not limited to: telephone calls (home, work, cell), cell phone SMS messages, FAX, pager (text/alphanumeric/voice), e-mail, instant messages (AOL, Yahoo, MSN, etc.), thereby affording flexibility in how contact is made.

In accordance with further aspects of various embodiments of the present invention, alarm system 200 is suitably able to respond to events based on numerous criteria, including, for exemplary purposes:

a) event type

b) event time

c) event location (site)

d) sensor type

e) sensor location (within the home/business)

f) which contact methods are available for the users in the address book for that site, and

g) user location (e.g. at home or work, on vacation, out of the country).

Additionally, alarm system 200 may suitably provide mechanisms for sequencing event notifications in an order determined by user 201, and/or provide for escalation of notifications to human dispatchers as required. Alarm system 200 may also be further extended to learn user's schedule and habits, in order to tune dispatch operations to match their life style (e.g., call one user if at work, call another user if on vacation, etc.).

In accordance with still further aspects of the present invention, various interfaces may be used to implement alarm system 200 including, but not limited to web sites (e.g., FIGS. 3-9) and/or and a voice call in system where by user 201 calls a specified phone number, and provides DTMF or voice command instructions to system 200 to change the configuration and/or operation of alarm system 200. For example, a typical voice call in system might use a Voice XML implementation of the dispatch configuration system 205. In such embodiments, voice based interface thereby allows user 201 access to the functionality of alarm system 200 including:

a) changing system configuration

b) checking system status, and

c) cancel/respond to event notifications.

In accordance with still another aspect of the present invention, dispatch mechanism 206 may also maintain a record/log of all alarm events, outgoing user contact attempts, and any resulting responses from users 201, 201a,b. Further still, alarm system 200 may provide support similar to typical alarm system functionality such as allowing users 201, 201a,b to enter a PIN (numeric digits password) or password to cancel the event in the event of a false alarm. Alarm system 200 may also support standard human-operator dispatch capabilities in the event a user contact cannot be reached, or fails to enter the valid PIN/password for the account. Likewise, a human operator dispatch capability may support the ability to contact local fire/police authorities in the appropriate cases, thus acting as a fail-safe mechanism as in existing alarm systems.

Finally, it should be appreciated that the present invention has been described above with reference to various exemplary embodiments. However, many changes, combinations and modifications may be made to the exemplary embodiments without departing from the scope of the present invention. For example, the various components may be implemented in alternate ways. These alternatives can be suitably selected depending upon the particular application or in consideration of any number of factors associated with the operation of the system. In addition, the techniques described herein may be extended or modified for use with other types of devices. These and other changes or modifications are intended to be included within the scope of the present invention.

We claim:

1. A configurable alarm system, comprising at least one user interface which interfaces with:
at least one alarm sensor;
a dispatch configuration system through which a user configures an alarm notification parameter, wherein said alarm notification parameter defines a primary action to be executed if a pre-defined alarm event occurs; and
an automated dispatch mechanism, wherein said automated dispatch mechanism executes said primary action upon occurrence of said pre-defined alarm event.

2. The configurable alarm system of claim 1, further comprising multiple alarm notification parameters, wherein each of said alarm notification parameters defines a distinct primary action to be executed based on a distinct pre-defined alarm event associated with each of said alarm notification parameters.

3. The configurable alarm system of claim 2, wherein each of said alarm notification parameters is independent of the other of said alarm notification parameters.

4. The configurable alarm system of claim 2, wherein at least two of said alarm notification parameters correspond to one pre-defined alarm event, and define at least two different primary actions to be executed based on said one pre-defined alarm event.

5. The configurable alarm system of claim 4, wherein said at least two different primary actions are executed in parallel.

6. The configurable alarm system of claim 4, wherein said at least two different primary actions are executed consecutively.

7. The configurable alarm system of claim 1, further comprising a secondary alarm notification parameter defining at least one secondary action to be executed.

8. The configurable alarm system of claim 7, wherein said secondary action is executed in the event said primary action fails.

9. The configurable alarm system of claim 1, wherein said primary action comprises a notification to a first person defined by said user.

10. The configurable alarm system of claim 9, further comprising a notification to a second person defined by said user in the event said first person cannot be contacted.

11. The configurable alarm system of claim 1, further comprising transfer of a data packet to a pre-defined location upon occurrence of said pre-defined alarm event.

12. The configurable alarm system of claim 11, wherein said data packet comprises information relating to said pre-defined alarm event.

13. The configurable alarm system of claim 12, wherein said information is used to authenticate said pre-defined alarm event prior to executing said primary action.

14. The configurable alarm system of claim 1, wherein said primary action activates a camera which transmits an image of the vicinity proximate to said alarm sensor to a pre-defined location.

15. The configurable alarm system of claim 1, wherein said interface is remotely connected to said dispatch configuration system.

16. The configurable alarm system of claim 15, wherein said interface is remotely connected to said dispatch configuration system via the Internet.

17. The configurable alarm system of claim 1, further comprising a electronically retrievable status indicator.

18. The configurable alarm system of claim 17, wherein said status indicator comprises an automated call in server providing call-in status capability to determine a status of a monitored area.

19. The configurable alarm system of claim 1, wherein said alarm notification parameters are downloaded from a database containing a plurality of pre-defined alarm notification parameters.

20. A system for handling an alarm event, comprising the steps of:
providing an interface device for communicating with at least one alarm sensor, a dispatch configuration system and a dispatch mechanism;
configuring said dispatch configuration system with an alarm notification parameter, said alarm notification parameter defining a primary action to be executed if a pre-defined alarm event occurs; and
automatically executing said primary action upon occurrence of said pre-defined alarm event.

21. The system of claim 20, further comprising the step of providing multiple alarm notification parameters, each of said alarm notification parameters defining different primary actions to be executed based on a single pre-defined alarm event.

22. The system of claim 20, further comprising the step of validating the occurrence of said pre-defined alarm event prior to executing said primary action.

23. The system of claim 22, further comprising the step of proceeding with said primary action if validation does not occur within a pre-determined period of time.

24. The system of claim 22, further comprising the step of proceeding with a back-up action if validation does not occur within a pre-determined period of time.

25. The system of claim 22, wherein said validating step comprises:
sending a user an image of an area proximate to said alarm sensor upon notification of an occurrence of said pre-defined alarm event to a user to confirm said occurrence of said pre-defined event; and
prompting said user to authorize at least one of said different primary actions.

26. The system of claim 21, further comprising the step of prioritizing said multiple alarm notification parameters based on user input variables.

27. The system of claim 26, wherein said user input variables are time periods, and wherein each time period is associated with one of said primary actions.

28. The system of claim 20, further comprising the step of providing a status indicator to said user.

29 The system of claim 28, wherein said step of providing a status indicator to said user is provided via said user calling an automated status server upon occurrence of said pre-defined alarm event.
